(19) United States
(12) Patent Application Publication
(10) Pub. No.: US 2014/0335858 A1
(43) Pub. Date: Nov. 13, 2014

(54) CELL SEARCH METHOD FOR SUPPORTING DISCONTINUOUS TRANSMISSION AND/OR RECEPTION OF BASE STATION

(71) Applicant: Electronics & Telecommunications Research Institute, Daejeon (KR)

(72) Inventors: Jun Hwan LEE, Seoul (KR); Tae Soo KWON, Daejeon (KR)

(73) Assignee: Electronics & Telecommunications Research Institute, Daejeon (KR)

(21) Appl. No.: 14/272,766

(22) Filed: May 8, 2014

(30) Foreign Application Priority Data
May 8, 2013 (KR) 10-2013-0051887
May 7, 2014 (KR) 10-2014-0053924

(51) Int. Cl. H04W 52/02; H04W 48/16

(52) U.S. Cl. CPC H04W 52/0206; H04W 48/16
USPC 455/434

(57) ABSTRACT

Disclosed is a cell search method for supporting discontinuous transmission and reception of small cell base stations. A cell search method performed by a base station, in an environment that a plurality of small cell base stations perform discontinuous transmission and reception, may comprise transmitting information about small cell base stations whose current transmission and reception mode is in active state; receiving, from a terminal, measurement results on the small cell base stations included in the information about small cell base stations; estimating small cell base stations located around the terminal based on the measurement results; and transmitting, to the estimated small cell to stations, an instruction to change their transmission and reception modes. Therefore, power consumption of the small cell base stations may be reduced with maintaining terminal performances for searching small cells.

### CLAIM FOR PRIORITY

This application claims priorities to Korean Patent Applications No. 10-2013-0051887 filed on May 8, 2013 and No. 10-2014-0053924 filed on May 7, 2014 in the Korean Intellectual Property Office (KIPO), the entire contents of which are hereby incorporated by reference.

### BACKGROUND

1. Technical Field

Example embodiments of the present invention relate in general to a technology for small cell enhancements, and more specifically, to a cell search method for supporting discontinuous transmission and reception of base stations that can be applied to an environment in which base stations perform discontinuous transmission and reception.

2. Related Art

Due to wide distribution of mobile terminals and tablet PCs and rapid advancement of mobile computing based on wireless internet technologies, innovative increase of wireless network capacity is being demanded.

In many studies, it is predicted that traffic amount of mobile users will increase rapidly. An adoption of a new advanced physical layer technology or allocation of additional spectrums is being considered as the representative solutions to satisfy the above rapid explosive increase of traffic amount.

However, technologies such as frequency modulation/demodulation, channel coding, and multi-antenna are already approaching their theoretical limits, and allocation of additional frequency spectrum also cannot be a fundamental solution for capacity expansion of cellular networks.

As an effort for enhancing capacities of wireless communication systems, a method, in which a plurality of small cells are used to maximize spatial frequency reuse ratio so as to enhance capacities which can be actually provided to users, is being focused currently. A miniaturization of a cell may have advantages in increasing user capacity and decreasing backward transmission power so that power consumption of a terminal may be reduced.

On the other hand, in order for a terminal to establish a connection with an arbitrary cell, or to perform handover for supporting mobility of the terminal, a technique for cell search is necessary. In an environment of small cells, since many cells exist around the terminal and the size of cells is small, frequent handover situations may occur. Accordingly, in such the small cell environment, neighbor cell searches may affect service qualities and power consumptions of the terminal. Therefore, fast, low-power consuming, and efficient cell search methods are needed for the small cell environment.

In the conventional cell search procedures, a terminal measures and compares signals (for example, synchronization signals) broadcasted by base stations, and then selects a serving cell based on the comparison result. Especially, in case of handover, a method, in which a terminal receives a measurement set list including information about neighbor cells from a serving base station and a terminal searches neighbor cells based on the received measurement set list, is used.

On the other hand, as compared to a macro base station which provides services for wide area, since a small base station usually provides services for small area, a case in which service target users do not exist around the small cell base station may happen according to user distribution around the small cell base station. Also, in order to minimize power consumption of a small cell base station itself, a discussion, for introducing discontinuous transmission (DTX) and/or discontinuous reception (DRX) to a small cell base station similarly to the DRX operation of the conventional mobile terminal, is being performed.

In the environment in which small base stations perform DTX and/or DRX operations, when a terminal searches small cells around the terminal by measuring signals transmitted from the small cell base stations, the terminal may not discover small cell base stations performing DRX operation, or it may take too much time for the terminal to discover small cell base stations performing DRX operation.

As described above, when a terminal performs cell searches in an environment that a plurality of small cell base stations perform DTX and/or DRX operations, there is a trade-off between cell search performance of terminals and power consumption of small cell base stations. That is, it is preferred to maintain small cell base stations in active station in order to enhance cell search performances of terminals. However, it increases power consumptions of small cell base stations. Also, if DTX and/or DRX operations are performed into reduce power consumption of small cell baser stations, power consumption of terminals may be increased as cell search overhead of terminals is increased.

Therefore, a method for minimizing power consumption of small cell base stations without decreasing cell search performances of terminals is needed.

### SUMMARY

Accordingly, example embodiments of the present invention are provided to substantially obviate one or more problems due to limitations and disadvantages of the related art. Especially, the method of discovering adjacent devices or services is needed for providing various mobile services, such as a local advertisement targeting to potential customers, finding a taxi with vacant seats, a mobile game with adjacent gamers and finding vacant parking lots, without a help of GPS or intervening user.

Example embodiments of the present invention provide a cell search method which can reduce power consumption of small cell base stations without degrading cell search performance of terminals.

In an example embodiment, a cell search method performed by a base station, in an environment in which a plurality of small cell base stations perform discontinuous transmission and reception, the method may comprise transmitting information about small cell base stations whose current transmission and reception mode is in active state; receiving, from a terminal, measurement results on the small cell base stations included in the information about small cell base stations; estimating small cell base stations located around the terminal based on the measurement results; and transmitting, to the estimated small cell stations, an instruction to change their transmission and reception modes.

Here, the plurality of small cell base stations may be grouped into at least one region according to their physical positions.

Also, in the estimating small cell base stations located around the terminal, a region comprising a small cell base station located in the nearest position from the terminal may be estimated, and the estimated region may comprise at least one small cell base station whose current transmission and reception mode is in active state or in inactive state, and a small cell base station whose transmission and reception mode is in inactive state may switch its transmission and reception mode into active state in response to the instruction from the base station.

Here, the method may further comprise receiving acknowledgements in response to the instruction from the estimated small cell base stations; transmitting information about the estimated small cell base stations to the terminal; and receiving measurement results for the estimated small cell base stations from the terminal.

In another example embodiment, a cell search method performed by a base station, in an environment in which a plurality of small cell base stations perform discontinuous transmission and reception, the method may comprise allocating a terminal-specific signal to a terminal; transmitting information about the terminal-specific signal to the plurality of small cell base stations; receiving measurement results on the terminal-specific signal from small cell base stations whose current transmission and reception mode is in active state; estimating small cell base stations located around the terminal based on the measurement results; and transmitting, to the estimated small cell stations, an instruction to change their transmission and reception modes.

Here, the method may further comprise receiving acknowledgements in response to the instruction from the estimated small cell base stations; transmitting a measurement set list including information about the estimated small cell base stations to the terminal; and receiving measurement results for the estimated small cell base stations from the terminal.

Here, the estimated small cell base stations may include at least one small cell base station whose current transmission and reception mode is in active state or in inactive state, and a small cell base station whose transmission and reception mode is in inactive state may switch its transmission and reception mode into active state in response to the instruction from the base station.

Here, the method may further comprise receiving acknowledgements in response to the instruction from the estimated small cell base stations; transmitting, to the terminal, an instruction to broadcast the terminal-specific signal; and receiving measurement results for the estimated small cell base stations from the terminal.

In other example embodiment, a cell search method performed by a small cell base station, in an environment in which a plurality of small cell base stations perform discontinuous transmission and reception, the method may comprise, when transmission and reception mode is in active state or in inactive state, receiving an instruction to change the transmission and reception mode from a base station; when the transmission and reception mode is in inactive state, switching the transmission and reception mode into active state in response to the instruction; and broadcasting a forward signal for cell search after the transmission and reception mode is switched into the active state.

Here, the method may further comprise, prior to the receiving an instruction to change the transmission and reception mode from a base station, broadcasting a forward signal for cell search when the transmission and reception mode is in active state.

Here, the method may further comprise, prior to the receiving an instruction to change the transmission and reception mode from a base station, receiving information about a terminal-specific signal from the base station when transmission and reception mode is in active state or in inactive state, performing measurement on the terminal-specific signal received when the transmission and reception mode is in active state, and reporting results of the measurement to the base station.

Here, the plurality of small cell base stations may be grouped into at least one region according to their physical positions.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a cell search operation of a terminal in an environment in which small cell base stations perform DRX/DTX operations;

FIG. 2 is a view illustrating a cell search operation of a terminal based on information provided from a macro base station in an environment in which small cell base stations perform DRX/DTX operations;

FIG. 3 is a view illustrating a cell search operation of a terminal based on backward signal of a terminal in an environment in which small cell base stations perform DRX/DTX operations;

FIG. 4 is a timing diagram illustrating operations of small cell base stations performing DTX/DRX operations;

FIG. 5 is a conceptual diagram illustrating an example of grouping small cell base stations to which a cell search method according to an example embodiment of the present invention is applied;

FIG. 6 is a timing diagram illustrating DTX/DRX operations of small cell base stations belonging to a second region depicted in FIG. 5;

FIG. 7 is a flow chart illustrating a cell search method according to an example embodiment of the present invention;

FIG. 8 is a flow chart illustrating a cell search method according to another example embodiment of the present invention; and

FIG. 9 is a flow chart illustrating a cell search method according to still another example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

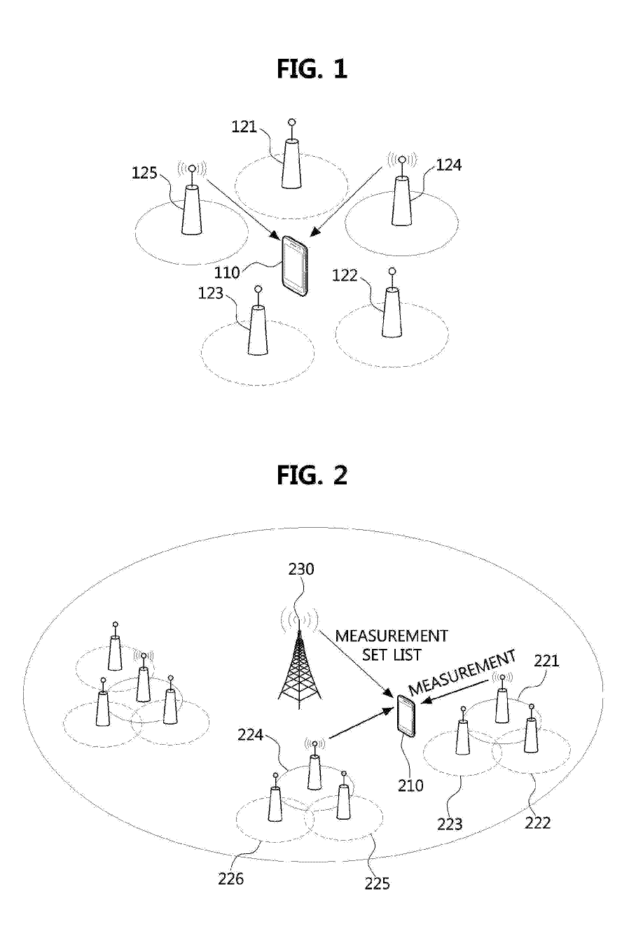

FIG. 1 is a view illustrating a cell search operation of a terminal in an environment in which small cell base stations perform DRX/DTX operations.

In an environment that a plurality of small cell base stations (or, small cells) 121, 122, 123, 124, and 125 exist near a terminal 110, if some of the small cell base stations 121, 122, and 123 do not perform transmission/reception due to DRX/DTX operation, the terminal 110 can receive only signals transmitted from the small cell base stations 124 and 125 whose current transmission mode is in active state. Also, signals transmitted from the terminal 110 can be received only by the small cell base stations 124 and 125 whose current reception mode is in active state.

For example, among the small cell base stations 121 to 125, if the small cell base stations 124 and 125 are in active transmission state at a certain time, and the small cell base stations 121 to 123 are in inactive transmission state at the same time, the terminal 110 can receive only signals transmitted from the small cell base stations 124 and 125 and perform cell search operations based on the received signals. Therefore, a cell search performance of the terminal 110 may be degraded.

In the environment illustrated in FIG. 1, the present invention provides a cell search method to minimize power consumption of terminals and small cell base stations by making small cell base station perform DTX/DRX operations without degrading cell search performances of terminals.

FIG. 2 is a view illustrating a cell search operation of a terminal based on information provided from a macro base station in an environment in which small cell base stations perform DRX/DTX operations.

Referring to FIG. 2, a terminal 210 which establishes a connection with a macro base station 230 receives a measurement set list including information about small cell base stations around the terminal 210 from the macro base station 230, and measures signals received from the small cell base stations around the terminal 210 based on the received measurement set list. At this time, if some of the small cell base stations (for example, 222, 223, 225, and 256) included in the measurement set list are in inactive transmission mode while performing DTX/DRX operations, the terminal 210 cannot measure signals from the small cell base stations 222, 223, 225, and 256 performing DTX/DRX operations so that the small cell base stations 222, 223, 225, and 256 cannot be discovered.

For example, although all of the small cell base stations 221 to 226 are included in the measurement set list, since the small cell base stations 222, 223, 225, and 256 do not transmit signals due to their DTX/DRX operations, the terminal 210 cannot discover the corresponding small cell base stations 222, 223, 225, and 226.

The present invention provides a cell search method based on measurement of small cell base station signal in order to overcome the above-described problem.

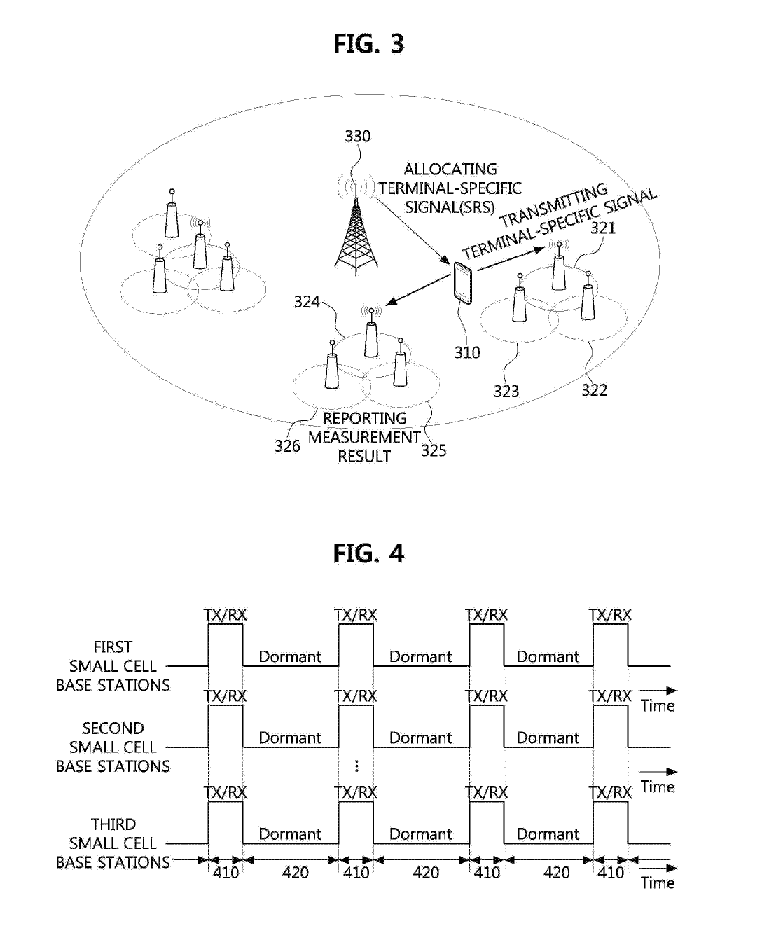

FIG. 3 is a view illustrating a cell search operation of a terminal based on backward signal of a terminal in an environment in which small cell base stations perform DRX/DTX operations.

Referring to FIG. 3, a macro base station 330 may allocate a terminal-specific signal for cell search to a terminal 310. Here, the terminal-specific signal may be a backward signal which can be used to distinguish the terminal from other terminals, and may be, for example, a Sounding Reference Signal (SRS). The terminal 310 may transmit the terminal-specific signal allocated from the macro base station 330. The small cell base stations 321 and 324 located around the terminal 310 may measure the terminal-specific signal transmitted from the terminal 310, and report measurement results to the macro base stations 330 or an apparatus managing inter-cell mobility. The macro base station 330 or the apparatus managing inter-cell mobility may generate a measurement set list including information about the small cell base stations around the terminal 310 based on the measurement results, and transmit the measurement set list to the terminal 310. Alternatively, the macro base station 330 or the apparatus managing inter-cell mobility may determine a serving small cell for the terminal 310 among the small cell base stations around the terminal 310 directly, and report the selected serving small cell to the terminal 310.

However, in the above-described cell search procedure illustrated in FIG. 3, the small cell base stations 322, 323, 325, and 326 performing DRX operations cannot receive the backward signal transmitted from the terminal 310, and report measurement results. As a result, the small cell base stations 322, 323, 325, and 326 performing DRX operations are excluded in the cell search of the terminal 310.

Therefore, the present invention provides a cell search method in order to overcome the above-described problem occurring in a cell search procedure of a terminal based on backward signal of a terminal.

The present invention provides operation methods of a terminal (UE; User Equipment), a macro base station (eNB; enhanced Node B), and a small cell base station (SeNB; Small cell eNB) which can search small cells around a terminal in an environment that small cell base stations perform DTX/DRX operation to reduce power consumption.

FIG. 4 is a timing diagram illustrating operations of small cell base stations performing DTX/DRX operations.

In FIG. 4, it is assumed that first to third small cell base stations are performing DTX/DRX operations and data transmission/reception periods 410 and dormant periods 420 of the first to third small cell base stations are configured identically.

As shown in FIG. 4, in a case that the small cell base stations performing DTX/DRX operations perform transmissions and receptions at the same time, a terminal may perform a cell search in the data transmission/reception periods of the small cell base stations by a cell search method identical to the conventional cell search method.

However, in a dense small cell environment, if a terminal does not have information about small cell base stations located around the terminal, a problem that the terminal should search a great number of small cells still exists.

On the contrary, if small cell base stations perform DTX/DRX operations with different data transmission/reception periods and dormant periods, a problem that only some of the small cell base stations around the terminal can be discovered by the terminal at a certain time exists. That is, only the small cell base stations transmission/reception mode of which is in active state can be discovered.

Instead of configuring data transmission/reception periods and dormant periods of the small cell base stations identically or differently, the present invention provides a method reducing power consumption of small cell base stations and cell search load of a terminal by configuring dormant periods of the small cell base stations longer than those of the conventional base stations.

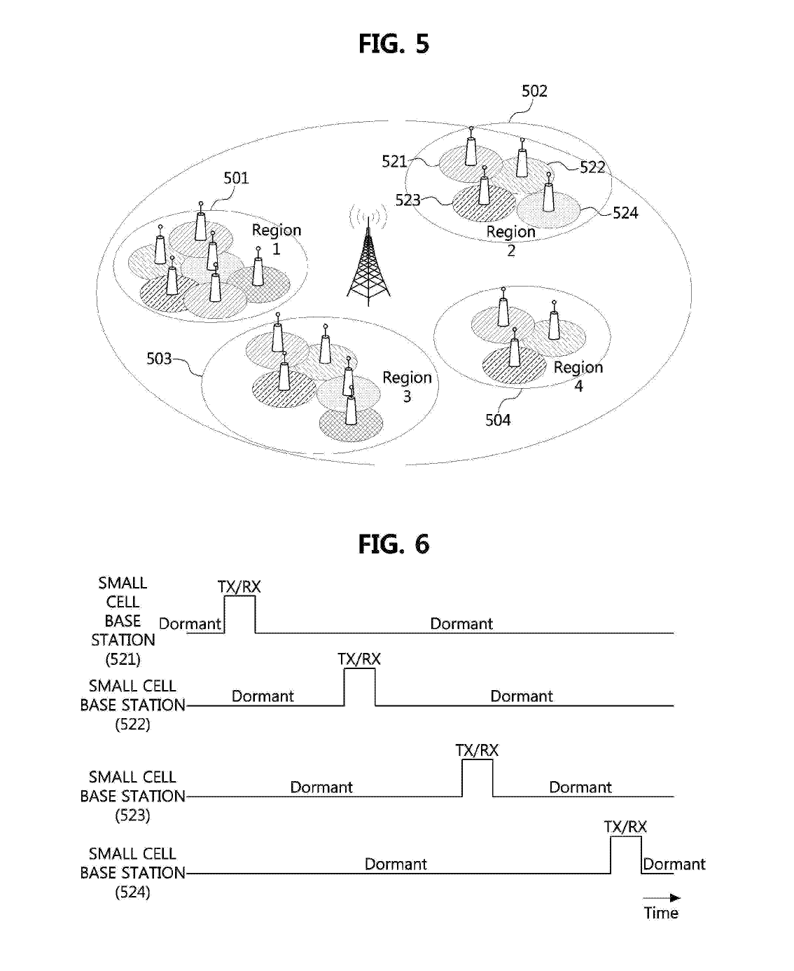

Hereinafter, a cell search method according to an example embodiment of the present invention is explained in detail by referring to FIGS. 5 to 9.

In the present invention, when a macro cell and a plurality of small cells within service coverage of the macro cell exist together, the service coverage is divided into several regions by grouping small cells physically located in near positions.

FIG. 5 is a conceptual diagram illustrating an example of grouping small cell base stations to which a cell search method according to an example embodiment of the present invention is applied. Also, FIG. 6 is a timing diagram illustrating DTX/DRX operations of small cell base stations belonging to a second region depicted in FIG. 5.

In FIG. 5, the small cells located in the macro cell are grouped into four regions 501, 502, 503, and 504 according to their physical positions. Also, the coverages of the plurality of small cell base stations are overlapped with the coverage of the macro cell.

As shown in FIG. 6, operation parameters of DTX/DRX for small cell base stations belonging to each of the regions 501 to 504 may be configured so that small cell base stations belonging to the same region perform transmissions and receptions in turn. In this case, respective dormant period of the small cell base stations belonging to each region may become longer as compared to the case of FIG. 4. However, DTX/DRX operation parameters can be configured so that each region has DTX/DRX periods identical to those of other regions in view of regions.

Alternatively, DTX/DRX periods of small cell base stations belonging to each of the regions 501 to 504 may be configured identically as shown in FIG. 4. However, each region may have relatively shorter periods than DTX/DRX periods shown in FIG. 4. In this case, power consumption of small cell base stations may be maintained as identical to that of the conventional method, and cell search performance of terminals may be enhanced due to shorter DTX/DRX periods for each region.

For example, when the small cell base stations 521 to 524 belonging to the second region 502 illustrated in FIG. 5 are configured to perform DTX/DRX operations illustrated in FIG. 6, dormant periods for the small cell base stations 521 to 524 become longer than those of DTX/DRX operations depicted in FIG. 4 so that power consumption of each small cell base station may be reduced.

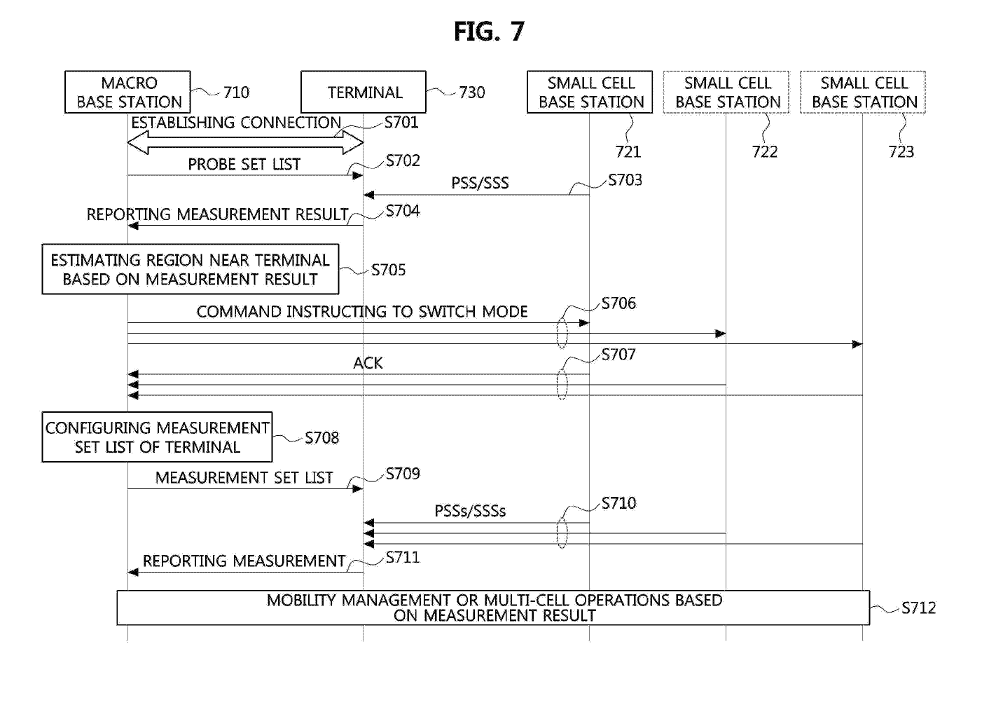

FIG. 7 is a flow chart illustrating a cell search method according to an example embodiment of the present invention. In FIG. 7, an example of a procedure, in which a terminal performs cell searches by measuring forward signals transmitted from small cell base stations in an environment that a plurality of small cell base stations perform DTX/DRX operations, is illustrated. Hereinafter, as shown in FIG. 5, it is assumed that a plurality of small cells are grouped into several regions according to their physical positions.

In FIG. 7, a cell search method is assumed to be started in an environment that a small cell base station 721 is in an active state and small cell base stations 722 and 723 are in an inactive state.

First, a terminal 730 may establish a connection with a macro base station 710 (S701).

The macro base station 710, based on information about small cell base stations which can transmit a signal for each region, may configure a probe set list including information about small cell base stations (for example, a small cell base station 721) which can transmit a signal currently, not all small cell base stations around the terminal 730, and transmit the probe set list to the terminal 730 (S702).

On the other hand, among the small cell base stations, the small cell base station 721 whose current transmission mode is in active state may transmit a forward signal (S703). Here, the forward signal may be, for example, a Primary Synchronization Signal (PSS) or a Secondary Synchronization Signal (SSS).

When the terminal 730 receives the probe set list from the macro base station 710, the terminal 730 may measure forward signals transmitted from small cell base stations belonging to regions adjacent to the terminal 730 based on the probe set list, and report the measurement result to the macro base station 710 (S704). Here, the small cell base stations transmitting the forward signals may be small cell base stations current transmission mode of which is in active state.

The macro base station 710 may estimate a position of the terminal 730 and regions near the position of the terminal 730 based on the measurement result reported from the terminal 730 (S705). For example, the macro base station 710 may determine a small cell base station which is in the nearest position from the terminal 730 based on reception powers of small cell base stations reported from the terminal 730, and estimate a region which the small cell base station is belonging to as a region adjacent to the terminal 730.

Then, the macro base station 710 may transmit a mode switching request message to switch transmission/reception modes of the small cell base stations belonging to the estimated region to active state to the small cell base stations belonging to the estimated region (S706). Here, the macro base station 710 may transmit the mode switching request message to all of the small cell base station 721 being currently in active transmission/reception state and the small cell base stations 722 and 723 being currently in dormant state. Also, the macro base station 710 may transmit the mode switching request message to the small cell base stations 721, 722, and 723 via wired or wireless backhaul connecting the macro base station 710 and the small cell base station 721, 722, and 723.

When the small cell base stations 721, 722, and 723 belonging to the estimated region receives the mode switching request message from the macro base station 710, they may switch transmission/reception mode to active state, and transmit acknowledgement messages for the mode switching message to the macro base station 710 (S707). Here, the small cell base station 721 being currently in active state may maintain its state, and the small cell base stations 722 and 723 being currently in dormant state may be switched into active state.

When the macro base station 710 receives the acknowledgement message from the small cell base stations 721 to 723 belonging to the estimated region, the macro base station 710 may generate a measurement set list including information about small cell base stations around the terminal 730 (S708), and transmit the generated measurement set list to the terminal 730 (S709).

Meanwhile, the small cell base stations 721 to 723 whose transmission/reception mode is switched into active state in the step S707 may broadcast forward signal (for example, PSS/SSS) (S710).

The terminal 730 may measure the forward signals broadcasted by the small cell base stations 721 to 723 based on the measurement set list received from the macro base station 710, and report the measurement result to the macro base station 710 (S711). Here, the terminal 730 may measure only the forward signals broadcasted by the small cell base stations 721 to 723 included in the measurement set list.

Then, multi-cell operations such as mobility management of the terminal 730, cooperative transmission of base stations, etc. may be performed based on the measurement result reported from the terminal 730 (S712).

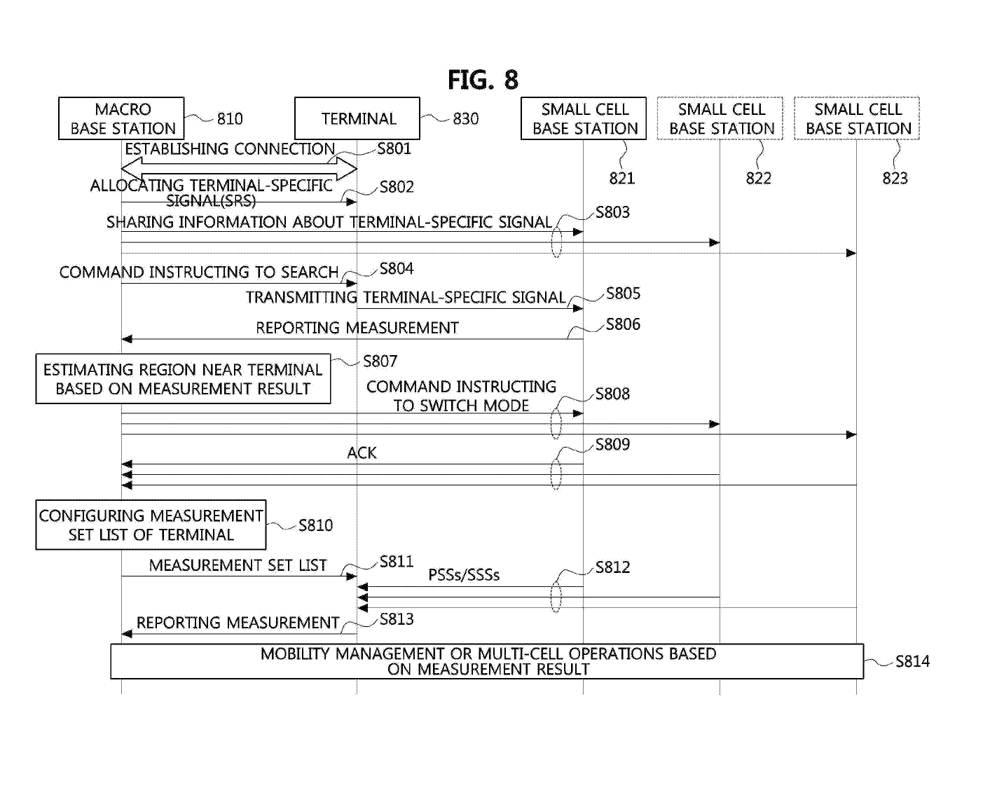

FIG. 8 is a flow chart illustrating a cell search method according to another example embodiment of the present invention.

In the environment that a plurality of small cell base stations perform DTX/DRX operations, an example, in which a cell search is performed based on measurement on a backward signal transmitted from a terminal and forward signals transmitted from the small cell base stations, is illustrated in FIG. 8. Hereinafter, it is assumed that a plurality of small cells are grouped into several regions according to their physical positions as shown in FIG. 5. Also, in FIG. 8, it is assumed that a cell search procedure is started when a transmission/reception mode of a small cell base station 821 is in active state and transmission/reception modes of small cell base stations 822 and 823 are in inactive state.

First, a terminal 830 may establish a connection with a macro base station 810 (S801).

When the connection is established with the terminal 830, the macro base station 810 may allocate a terminal-specific signal which can be used to distinguish the terminal 830 from other terminals to the terminal 830, and transmit information about the terminal-specific signal to the terminal 830 (S802). Here, the terminal-specific signal may be, for example, a Sounding Reference Signal (SRS). However, the terminal-specific signal is not restricted to a SRS. That is, the terminal-specific signal may be any signal which can be used for small cell base stations to distinguish the terminal 830 from other terminals.

Then, the macro base station 810 may share the information about the terminal-specific signal with the plurality of small cell base stations 821 to 823 by transmitting the information to them via wired or wireless back haul (S803). Here, the information related to the SRS may, for example, include resource allocation information such as a bandwidth for SRS transmission, a hopping bandwidth, a position on frequency region, a frequency shift, a cyclic shift, a period in a time domain, a subframe offset, and so on. Also, the terminal-specific signal may be transmitted to the small cell base stations 822 and 823 being currently in dormant state as well as the small cell base station 821 being currently in active transmission/reception state.

Then, when the macro base station 810 determines that the terminal 830 is required to search small cells around the terminal 830, the macro base station 810 may transmit, to the terminal 830, a command instructing to perform cell search (S804). For example, the macro base station 810 may determine whether to transmit the command to the terminal 830 according to movement of the terminal 830, change of frequency environment, or load status of the macro base station 810.

If the terminal 830 receives the command from the macro base station 810, the terminal 830 may generate the terminal-specific signal based on the information about the terminal-specific signal, and broadcast the terminal-specific signal (S805).

At least one small cell base station (for example, 821) whose current transmission/reception mode is in active state may monitor a corresponding resource based on the information about the terminal-specific signal received from the macro base station 810. When the terminal-specific signal is received, the small cell base station may perform measurement on the received terminal-specific signal, and report the measurement result to the macro base station 810 (or, an apparatus managing mobility of the terminal 830) (S806). At this time, the small cell base stations 822, 823 whose current transmission/reception mode is in dormant state cannot receive the terminal-specific signal, and so they cannot perform and report measurement on the terminal-specific signal.

The macro base station 810 which receives the measurement result from the at least one small cell base station whose transmission/reception mode is in active state may estimate a region adjacent to the terminal 830 based on the measurement result (S807).

Then, the macro base station 810 may transmit a mode switching request message to switch transmission/reception modes of the small cell base stations 821, 822, and 823 belonging to the estimated region to active state to the small cell base stations 821, 822, and 823 belonging to the estimated region (S806). Here, the macro base station 810 may transmit the mode switching request message to all of the small cell base station 821 being currently in active transmission/reception state and the small cell base stations 822 and 823 being currently in dormant state. Also, the macro base station 810 may transmit the mode switching request message to the small cell base stations 821, 822, and 823 via wired or wireless backhaul connecting the macro base station 810 and the small cell base station 821, 822, and 823.

When the small cell base stations 821, 822, and 823 belonging to the estimated region receives the mode switching request message from the macro base station 810, they may switch transmission/reception mode to active state, and transmit acknowledgement messages for the mode switching message to the macro base station 810 (S809). Here, the small cell base station 821 being currently in active state may maintain its state, and the small cell base stations 822 and 823 being currently in dormant state may be switched into active state.

When the macro base station 810 receives the acknowledgement message from the small cell base stations 821 to 823 belonging to the estimated region, the macro base station 810 may generate a measurement set list including information about small cell base stations around the terminal 830 (S810), and transmit the generated measurement set list to the terminal 830 (S811).

Meanwhile, the small cell base stations 821 to 823 whose transmission/reception mode is switched into active state in the step S809 may broadcast forward signal (for example, PSS/SSS) (S812).

The terminal 830 may measure the forward signals broadcasted by the small cell base stations 821 to 823 based on the measurement set list received from the macro base station 810, and report the measurement result to the macro base station 810 (S813). Here, the terminal 830 may measure only the forward signals broadcasted by the small cell base stations 821 to 823 included in the measurement set list.

Then, multi-cell operations such as mobility management of the terminal 830, cooperative transmission of base stations, etc. may be performed based on the measurement result reported from the terminal 830 (S814).

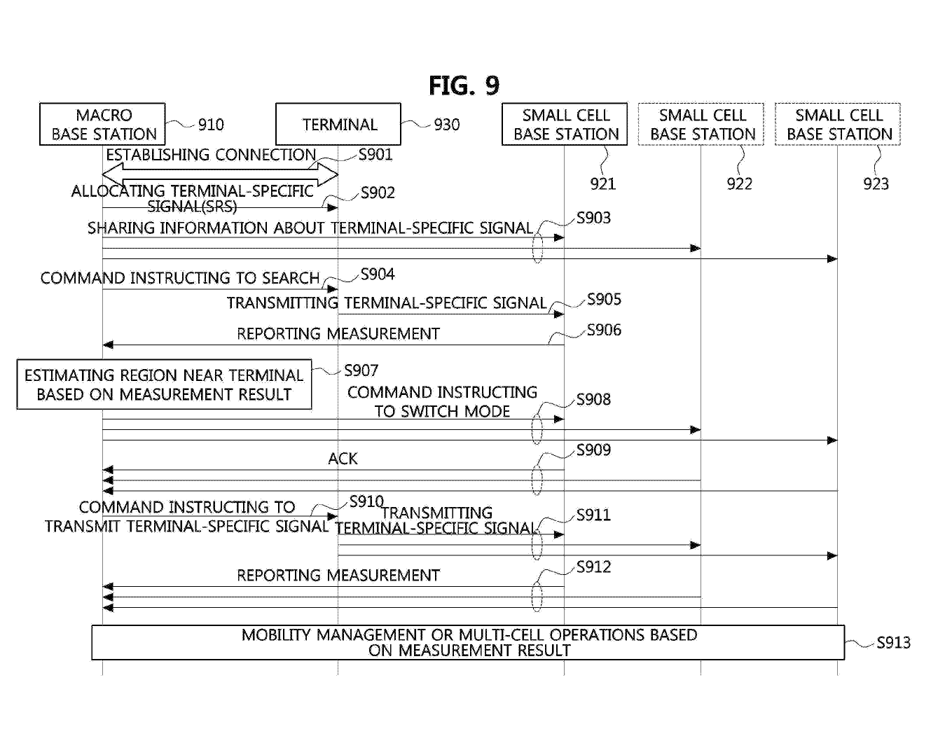

FIG. 9 is a flow chart illustrating a cell search method according to still another example embodiment of the present invention.

In the environment that a plurality of small cell base stations perform DTX/DRX operations, an example, in which a cell search is performed based on measurement on a backward signal transmitted from a terminal, is illustrated in FIG. 9. Hereinafter, it is assumed that a plurality of small cells are grouped into several regions according to their physical positions as shown in FIG. 5. Also, in FIG. 9, it is assumed that a cell search procedure is started when a transmission/reception mode of a small cell base station 921 is in active state and transmission/reception modes of small cell base stations 922 and 923 are in inactive state.

First, a terminal 930 may establish a connection with a macro base station 910 (S901).

When the connection is established with the terminal 930, the macro base station 910 may allocate a terminal-specific signal which can be used to distinguish the terminal 930 from other terminals to the terminal 930, and transmit information about the terminal-specific signal to the terminal 930 (S902). Here, the terminal-specific signal may be, for example, a Sounding Reference Signal (SRS). However, the terminal-specific signal is not restricted to a SRS. That is, the terminal-specific signal may be any signal which can be used for small cell base stations to distinguish the terminal 930 from other terminals.

Then, the macro base station 910 may share the information about the terminal-specific signal with the plurality of small cell base stations 921 to 923 by transmitting the information to them via wired or wireless back haul (S903). Here, the information related to the SRS may, for example, include resource allocation information such as a bandwidth for SRS transmission, a hopping bandwidth, a position on frequency region, a frequency shift, a cyclic shift, a period in a time domain, a subframe offset, and so on. Also, the terminal-specific signal may be transmitted to the small cell base stations 922 and 923 being currently in dormant state as well as the small cell base station 921 being currently in active transmission/reception state.

Then, when the macro base station 910 determines that the terminal 930 is required to search small cells around the terminal 930, the macro base station 910 may transmit, to the terminal 930, a command instructing to perform cell search (S904). For example, the macro base station 910 may determine whether to transmit the command to the terminal 930 according to movement of the terminal 930, change of frequency environment, or load status of the macro base station 910.

If the terminal 930 receives the command from the macro base station 910, the terminal 930 may generate the terminal-specific signal based on the information about the terminal-specific signal, and broadcast the terminal-specific signal (S905).

At least one small cell base station (for example, 921) whose current transmission/reception mode is in active state may monitor a corresponding resource based on the information about the terminal-specific signal received from the macro base station 910. When the terminal-specific signal is received, the small cell base station may perform measurement on the received terminal-specific signal, and report the measurement result to the macro base station 910 (or, an apparatus managing mobility of the terminal 930) (S906). At this time, the small cell base stations 922, 923 whose current transmission/reception mode is in dormant state cannot receive the terminal-specific signal, and so they cannot perform and report measurement on the terminal-specific signal.

The macro base station 910 which receives the measurement result from the at least one small cell base station whose transmission/reception mode is in active state may estimate a region adjacent to the terminal 930 based on the measurement result (S907).

Then, the macro base station 910 may transmit a mode switching request message to switch transmission/reception modes of the small cell base stations 921, 922, and 923 belonging to the estimated region to active state to the small cell base stations 921, 922, and 923 belonging to the estimated region (S906). Here, the macro base station 910 may transmit the mode switching request message to all of the small cell base station 921 being currently in active transmission/reception state and the small cell base stations 922 and 923 being currently in dormant state. Also, the macro base station 910 may transmit the mode switching request message to the small cell base stations 921, 922, and 923 via wired or wireless backhaul connecting the macro base station 910 and the small cell base station 921, 922, and 923.

When the small cell base stations 921, 922, and 923 belonging to the estimated region receives the mode switching request message from the macro base station 910, they may switch transmission/reception mode to active state, and transmit acknowledgement messages for the mode switching message to the macro base station 910 (S909). Here, the small cell base station 921 being currently in active state may maintain its state, and the small cell base stations 922 and 923 being currently in dormant state may be switched into active state.

Then, instead of generating a measurement set list including information about small cell base stations around the terminal 930 and transmitting it to the terminal 930 as shown in FIG. 8, the macro base station 910 may instruct the terminal 930 to broadcast the terminal-specific signal of the terminal 930 once again (S910). Here, the command instructing to broadcast the terminal-specific signal may be configured identically to the command instructing to search cell in the step S904.

If the terminal 930 receives the command from the macro base station 910, the terminal 930 may generate the terminal-specific signal based on the information about the terminal-specific signal, and broadcast the terminal-specific signal (S911).

Since transmission/reception modes of a plurality of small cell base stations 921 to 923 belonging to a region located near the terminal 930 (that is, the estimated region) are switched into active states, they can receive the terminal-specific signal broadcasted by the terminal 930, measure the received terminal-specific signal, and report the measured result to the macro base station 910 (or, an apparatus managing mobility of the terminal) (S912).

The macro base station 910 (or, the apparatus managing inter-cell mobility) may determine a serving small cell base station for the terminal 930 based on the measurement results reported from the plurality of small cell base stations. Then, multi-cell operations such as mobility management of the terminal 930, cooperative transmission of base stations, etc. may be performed based on the reported measurement result (S913).

According to the above-described cell search method, in a wireless network environment that a plurality of small cells are installed, DTX/DRX operations having relatively longer periods are allowed for the small cell base stations. Therefore, power consumption of the small cell base stations may be reduced with maintaining terminal performances for searching small cells.

Or, even when small cell base stations perform DTX/DRX operations in the conventional manner, terminal performances for searching small cells may be enhanced with maintaining power consumption of the small cell base stations.

While the example embodiments of the present invention and their advantages have been described in detail, it should be understood that various changes, substitutions and alterations may be made herein without departing from the scope of the invention.

What is claimed is:

1. A cell search method performed by a base station, in an environment in which a plurality of small cell base stations perform discontinuous transmission and reception, the method comprising:
transmitting information about small cell base stations whose current transmission and reception mode is in active state;
receiving, from a terminal, measurement results on the small cell base stations included in the information about small cell base stations;
to estimating small cell base stations located around the terminal based on the measurement results; and
transmitting, to the estimated small cell stations, an instruction to change their transmission and reception modes.

2. The method of claim 1, wherein the plurality of small cell base stations are grouped into at least one region according to their physical positions.

3. The method of claim 2,
wherein, in the estimating small cell base stations located around the terminal, a region comprising a small cell base station located in the nearest position from the terminal is estimated; and
wherein the estimated region comprises at least one small cell base station whose current transmission and reception mode is in active state or in inactive state, and a small cell base station whose transmission and reception mode is in inactive state switches its transmission and reception mode into active state in response to the instruction from the base station.

4. The method of claim 1, further comprising:
receiving acknowledgements in response to the instruction from the estimated small cell base stations;
transmitting information about the estimated small cell base stations to the terminal; and
receiving measurement results for the estimated small cell base stations from the terminal.

5. A cell search method performed by a base station, in an environment in which a plurality of small cell base stations perform discontinuous transmission and reception, the method comprising:
allocating a terminal-specific signal to a terminal;
transmitting information about the terminal-specific signal to the plurality of small cell base stations;
receiving measurement results on the terminal-specific signal from small cell base stations whose current transmission and reception mode is in active state;
estimating small cell base stations located around the terminal based on the measurement results; and
transmitting, to the estimated small cell stations, an instruction to change their transmission and reception modes.

6. The method of claim 5, further comprising:
receiving acknowledgements in response to the instruction from the estimated small cell base stations;
transmitting a measurement set list including information about the estimated small cell base stations to the terminal; and
receiving measurement results for the estimated small cell base stations from the terminal.

7. The method of claim 5, wherein the estimated small cell base stations include at least one small cell base station whose current transmission and reception mode is in active state or in inactive state, and a small cell base station whose transmission and reception mode is in inactive state switches its transmission and reception mode into active state in response to the instruction from the base station.

8. The method of claim 5, further comprising:
receiving acknowledgements in response to the instruction from the estimated small cell base stations;
transmitting, to the terminal, an instruction to broadcast the terminal-specific signal; and
receiving measurement results for the estimated small cell base stations from the terminal.

9. A cell search method performed by a small cell base station, in an environment in which a plurality of small cell base stations perform discontinuous transmission and reception, the method comprising:
when transmission and reception mode is in active state or in inactive state, receiving an instruction to change the transmission and reception mode from a base station;
when the transmission and reception mode is in inactive state, switching the transmission and reception mode into active state in response to the instruction; and
broadcasting a forward signal for cell search after the transmission and reception mode is switched into the active state.

10. The method of claim 9, further comprising, prior to the receiving an instruction to change the transmission and reception mode from a base station, broadcasting a forward signal for cell search when the transmission and reception mode is in active state.

11. The method of claim 9, further comprising, prior to the receiving an instruction to change the transmission and reception mode from a base station, receiving information about a terminal-specific signal from the base station when transmission and reception mode is in active state or in inactive state, performing measurement on the terminal-specific signal received when the transmission and reception mode is in active state, and reporting results of the measurement to the base station.

12. The method of claim 9, wherein the plurality of small cell base stations are grouped into at least one region according to their physical positions.
